(19) United States
(12) Patent Application Publication
(10) Pub. No.: US 2025/0307523 A1
(43) Pub. Date: Oct. 2, 2025

(54) ANTENNA DESIGN METHOD AND ELECTRONIC DEVICE

(71) Applicant: ASUSTeK COMPUTER INC., Taipei City (TW)

(72) Inventors: Sung-Mao Liao, Taipei City (TW); Chien-Ming Hsu, Taipei City (TW)

(73) Assignee: ASUSTeK COMPUTER INC., Taipei City (TW)

(21) Appl. No.: 19/050,130

(22) Filed: Feb. 11, 2025

(30) Foreign Application Priority Data
Mar. 29, 2024 (TW) 113112159

(51) Int. Cl. G06F 30/398; G06F 30/392; G06F 119/06; H04B 17/391

(52) U.S. Cl. CPC G06F 30/398; G06F 30/392; H04B 17/3912; G06F 2119/06

(57) ABSTRACT

An antenna design method and an electronic device are provided. The method includes the following steps. Antenna specification information and antenna environment information are obtained, wherein the antenna specification information includes a target antenna parameter and an antenna size. An antenna zone corresponding to the antenna size is divided into multiple grids. A conduction property is randomly assigned to each of the grids to generate a random antenna pattern. Optimization algorithm is executed based on the target antenna parameter and the random antenna pattern to obtain an optimized conduction property for each of the grids. An antenna pattern designed to meet the antenna specification information is determined based on the optimized conduction property of each of the grids.

### CROSS-REFERENCE TO RELATED APPLICATION

This application claims the priority benefit of Taiwan application serial no. 113112159, filed on Mar. 29, 2024. The entirety of the above-mentioned patent application is hereby incorporated by reference herein and made a part of this specification.

### BACKGROUND

### Technical Field

The disclosure is related to an antenna design method and electronic device.

### Description of Related Art

With the advancement of communication technology, using electronic devices with wireless communication capabilities has become very common. Antennas are the basic components for realizing wireless communication. An antenna is a device configured to receive or transmit electromagnetic waves, commonly found in applications such as wireless communication, radar, and RFID systems. The design of antennas may greatly affect their performance, including reception efficiency, transmission power, directionality, and bandwidth. When designing antennas, engineers need to consider many factors, including the required frequency band, antenna size, directional requirements, environmental conditions, etc.

Currently, the design of antennas mostly relies on engineers' experience and multiple software simulations to ensure that the antennas may work effectively and meet communication needs while considering both performance and real-world application environments. Therefore, antenna design often requires a long development time. Even more, it may be possible to obtain antenna design results that do not meet the needs due to insufficient development experience.

### SUMMARY

The disclosure provides an antenna design method, which includes the following steps. Antenna specification information and antenna environment information are obtained, wherein the antenna specification information includes a target antenna parameter and an antenna size. An antenna zone corresponding to the antenna size is divided into multiple grids. A conduction property is randomly assigned to each of the grids to generate a random antenna pattern. Optimization algorithm is executed based on the target antenna parameter and the random antenna pattern to obtain an optimized conduction property for each of the grids. An antenna pattern designed to meet the antenna specification information is determined based on the optimized conduction property of each of the grids.

The disclosure also provides an electronic device, which includes a storage device and a processor. The storage device records multiple instructions. This processor couples the storage device and accesses these instructions to perform the following operations. Antenna specification information and antenna environment information are obtained, wherein the antenna specification information includes a target antenna parameter and an antenna size. An antenna zone corresponding to the antenna size is divided into multiple grids. A conduction property is randomly assigned to each of the grids to generate a random antenna pattern. Optimization algorithm is executed based on the target antenna parameter and the random antenna pattern to obtain an optimized conduction property for each of the grids. An antenna pattern designed to meet the antenna specification information is determined based on the optimized conduction property of each of the grids.

Based on the above, in this embodiment, the antenna zone may be divided into multiple grids. Afterwards, an optimization algorithm may be executed based on the target antenna parameter to determine the optimized conduction property of each grid in the antenna zone. Therefore, based on the optimized conduction property of each grid, the antenna pattern designed to meet the needs may be determined. In other words, by using an optimization algorithm to determine the optimized conduction property of each grid, an antenna pattern designed to meet the needs may be automatically determined, greatly improving the efficiency of antenna design.

### BRIEF DESCRIPTION OF THE DRAWINGS

FIG. 1 is a schematic diagram of an electronic device according to an embodiment of the disclosure.

FIG. 2 is a flowchart of an antenna design method according to an embodiment of the disclosure.

FIG. 3 is a schematic diagram of an antenna zone and multiple grids according to an embodiment of the disclosure.

FIG. 4 is a flowchart of generating a random antenna pattern according to an embodiment of the disclosure.

FIG. 5 is a flowchart for obtaining the optimized conduction property of each grid according to an embodiment of the present disclosure.

FIG. 6 is a flowchart for obtaining the optimized conduction property of each grid according to an embodiment of the present disclosure.

FIG. 7A and FIG. 7B are schematic diagrams of an optimization algorithm executed according to an embodiment of the disclosure.

FIG. 8A to FIG. 8C are schematic diagrams of determining the antenna pattern according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same component symbols are used in the drawings and descriptions to represent the same or similar parts. These embodiments are only part of the present disclosure and do not reveal all possible implementation modes of the present disclosure. Rather, these embodiments are merely examples of devices and methods within the scope of this patent application.

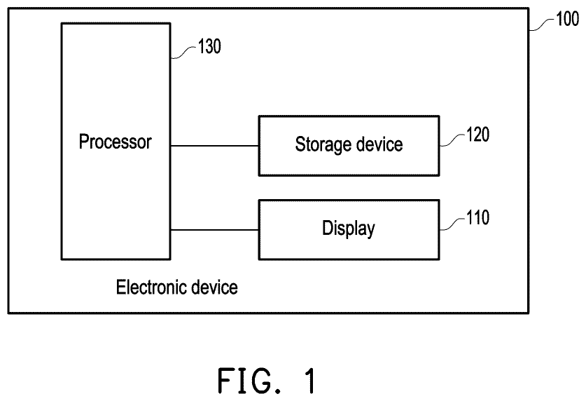

Referring to FIG. 1, the electronic device 100 of one embodiment is, for example, a computer device or a server device with computing capabilities. The disclosure is not limited thereto. The electronic device 100 includes a display 110, a storage device 120 and a processor 130, whose functions are described as follows.

The display 110 is configured to display images to users. The display 110 is, for example, a liquid crystal display (LCD), a light-emitting diode (LED) display, a field emission display (FED), or an organic light-emitting diode display (OLED) or other types of displays, but the disclosure is not limited thereto.

The storage device 120 is configured to store files, images, instructions, program codes, software modules, etc., which may be, for example, any type of fixed or removable random access memory (RAM), read-only memory (ROM), flash memory, hard disk or other similar devices, integrated circuits, or combinations thereof.

The processor 130 is, for example, a central processing unit (CPU), an application processor (AP), or other programmable general-purpose or special-purpose microprocessor, digital signal processor (DSP), programmable controller, Application Specific Integrated Circuits (ASIC), Programmable Logic Device (PLD), Graphics Processing Unit (GPU) or other similar devices or a combination of these devices. The processor 130 may execute the program codes, software modules, instructions, etc. recorded in the storage device 120 to implement the antenna design method in an embodiment. The above software modules may be broadly interpreted to mean instructions, instruction sets, codes, programs, programs, applications, software packages, threads, programs, functions, etc.

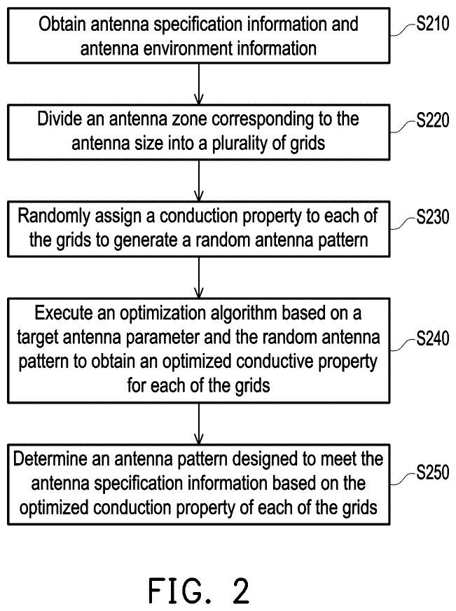

FIG. 2 is a flowchart of an antenna design method according to an embodiment of the disclosure. Referring to FIG. 1 and FIG. 2, the method of one embodiment is applicable to the electronic device 100 in the above embodiment. The detailed steps of the antenna design method of this embodiment are explained below with reference to various components in the electronic device 100.

In step S210, the processor 130 may obtain antenna specification information and antenna environment information. Antenna specification information includes target antenna parameter and an antenna size. The antenna size may include antenna width and antenna length. In addition, in some embodiments, the antenna specification information also includes the location of the signal feed point.

In some embodiments, the target antenna parameter may include a target operating frequency band and a S parameter requirement. For example, when designing a Wi-Fi dual-band antenna, the target operating frequency band may include a first target operating frequency band corresponding to 2.4 GHz (for example, 2.4 GHz˜2.5 GHz) and a second target operating frequency band corresponding to 5 GHz (for example, 5.15 GHz˜5.85 GHz). In addition, the S-parameter requirement corresponding to the target operating frequency band may include an S-parameter target value corresponding to the target operating frequency band (for example, −6 db, but may not be limited thereto).

In some embodiments, the antenna environment information may be implemented as a geometric model of the surrounding environment of the antenna, which may include the installation position of the antenna, the size of surrounding objects, the shape of surrounding objects, the location of surrounding objects, and the material of surrounding objects, etc. The above-mentioned surrounding objects are, for example, various electronic components, substrates, or casings in wireless communication devices, etc.

In step S220, the processor 130 may divide an antenna zone corresponding to the antenna size into a plurality of grids. The antenna zone may be the antenna pattern design area of a patch antenna. In some embodiments, the processor 130 may divide the rectangular antenna zone into a grid array including the grids. In other words, the processor 130 may divide the antenna zone into M*N grids. However, the disclosure does not limit the grid size and grid number, which may be determined by the actual application and actual needs.

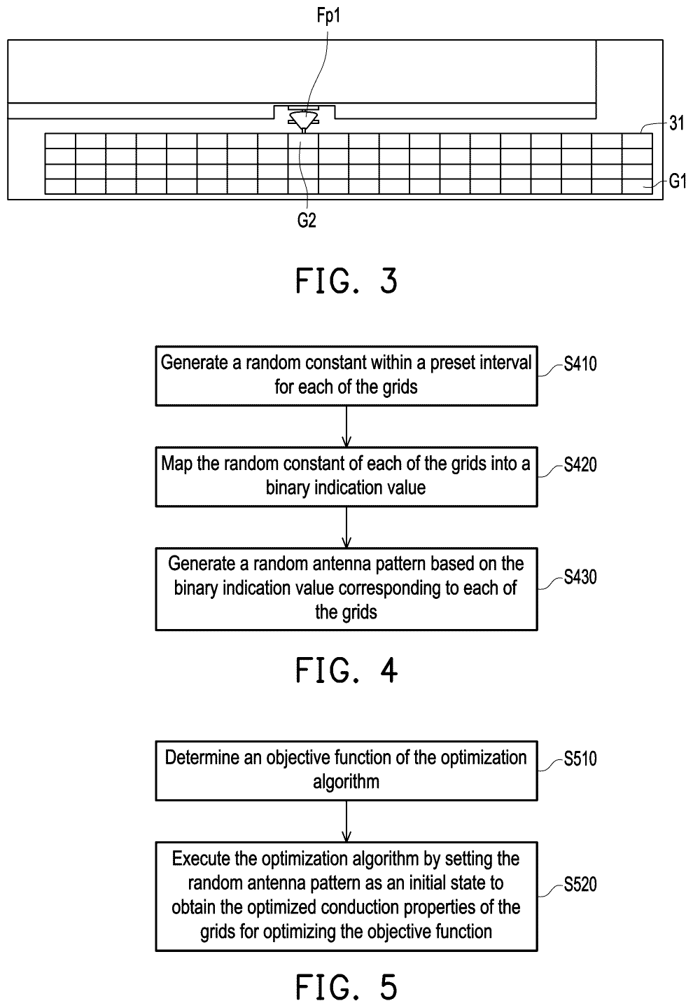

For example, referring to FIG. 3, after obtaining the antenna size, the processor 130 may divide the antenna zone 31 corresponding to the antenna size into 4*20 grids. In this embodiment, the grid size of each grid (for example, grid G1 and grid G2) in the antenna zone 31 is identical with each other. In addition, according to the position of the signal feed point, it is known that the grid G2 is connected to the signal feed point Fp1.

In step S230, the processor 130 may randomly assign a conduction property of each of the grids to generate a random antenna pattern. In some embodiments, the processor 130 may randomly assign the conduction property of each grid to be a conductive metal material or a non-conductive material (such as air), and the grids randomly assigned to be a conductive metal material may form a random antenna pattern.

Referring to FIG. 4, in some embodiments, step S230 may be implemented as step S410 to step S430. In step S410, the processor 130 may generate a random constant within a preset interval for each of the grids. That is to say, the processor 130 may randomly generate a random constant within the preset interval for each grid, so that each grid may correspond to one random constant within the preset interval. For example, the preset interval may be a value interval between −6 and 6, but is not limited thereto. The preset interval is a continuous value interval. In the disclosure, there is no limit on the upper limit value and lower limit value of the preset interval, which may be determined according to the actual application.

In step S420, the processor 130 may map the random constant of each of the grids into a binary indication value. The binary indication value corresponding to each grid is configured to indicate the conduction property of each grid. In some embodiments, the processor 130 may use a mapping function to map the random constant of each grid into binary indication values. The binary indication values of these grids may be the first value or the second value. In some embodiments, the processor 130 may map the random constant of each grid to 0 or 1. The above mapping function is, for example, a Sigmoid function, but it is not limited thereto. In other embodiments, the mapping function is, for example, a Tanh function.

For example, assume that the mapping function is a Sigmoid function. The sigmoid function may be, for example, 1/(1+exp^{-x}). After generating a random constant of one grid, the processor 130 may input the random constant to the Sigmoid function. Then, based on the comparison result between the function output value of the Sigmoid function and the random constant, the processor 130 may map the random constant to 0 or 1. When the function output value of the Sigmoid function is greater than the random constant, the processor 130 may map the random constant to 1. On the contrary, when the function output value of the Sigmoid function is less than the random constant, the processor 130 may map the random constant to 0. The above-mentioned operation of determining the binary indication value of each grid may be expressed as the following formula (1).

$$binary indication value = \{ \begin{matrix}1 , & if x < \frac{1}{1 + {e}^{- x}} \\ 0 , & if x > \frac{1}{1 + {e}^{- x}}\end{matrix} \qquad Formula ( 1 )$$

wherein, x represents the random constant corresponding to each grid.

In some embodiments, when the random constant of a first grid among the grids is within the first value range, the processor 130 may map the random constant of the first grid to the first value. When the random constant of the first grid in the grids is within the second value interval, the processor 130 may map the random constant of the first grid to the second value. For example, assume that the random constant for each grid is between −6 and 6. When the random constant of the first grid among the grids is between 0 and 6 (i.e., the first value interval of the preset interval), the processor 130 may map the random constant of the first grid to the first value. When the random constant of the first grid among the grids is between −6 and 0 (i.e., the second value interval of the preset interval), the processor 130 may map the random constant of the first grid to the second value.

In some embodiments, when the binary indication value of the first grid among the grids is the first value, the first grid is configured as a conductive metal material. When the binary indication value of the first grid among multiple grids is the second value, the first grid is configured as a non-conducting material. In some embodiments, the first value may be 1 and the second value may be 0.

In step S430, the processor 130 may generate a random antenna pattern based on the binary indication value corresponding to each of the grids. Specifically, after determining the binary indication value corresponding to each grid, the processor 130 may utilize a combination of multiple grids of which the binary indicator values equal to the first value as a random antenna pattern. In other words, the random antenna pattern is a pattern composed of partial grids in the antenna zone. The random antenna pattern may be used as an initial state of a optimization algorithm.

Referring to FIG. 2, in step S240, the processor 130 may execute an optimization algorithm based on the target antenna parameter and the random antenna pattern to obtain the optimized conduction property of each of the grids. The optimal conductivity property of each of the grids may be a conductive metal material or a non-conductive material.

Referring to FIG. 5, in some embodiments, step S240 may be implemented as step S510 to step S520. In step S510, the processor 130 may determine the objective function of the optimization algorithm. The optimization algorithm is, for example, a particle swarm optimization (Particle Swarm Optimization) algorithm, a genetic algorithm (Genetic Algorithm) or other optimization algorithms. The goal of an optimization algorithm is to search for a combination of variables that optimizes (such as maximizes or minimizes) an objective function. In some embodiments, the objective function may be a preset objective function provided by an optimizer of electromagnetic simulation software. The electromagnetic simulation software is, for example, CST Studio Suite, but it is not limited to this. In addition, in some embodiments, the processor 130 may define an objective function based on S parameters (e.g., S11 parameter) to optimize the S parameter of the designed antenna.

In step S520, the processor 130 may execute the optimization algorithm by setting the random antenna pattern as the initial state to obtain the optimized conduction property of multiple grids for optimizing the objective function. In some embodiments, the goal of the optimization algorithm includes making the S-parameter corresponding to the target operating frequency band meet the S-parameter requirement. In some embodiments, the goal of the optimization algorithm includes minimizing the S-parameter corresponding to the target operating frequency band. In some embodiments, by using the optimizer of the electromagnetic simulation software, the processor 130 may automatically and iteratively adjust the conduction property corresponding to each grid to generate different antenna patterns until the termination condition of the optimization algorithm is met. Therefore, when the termination condition of the optimization algorithm is met, the processor 130 may obtain the optimized conduction property of each grid, and the optimized conduction property of these grids may optimize the objective function to cause the simulated antenna parameter meet the antenna target parameter.

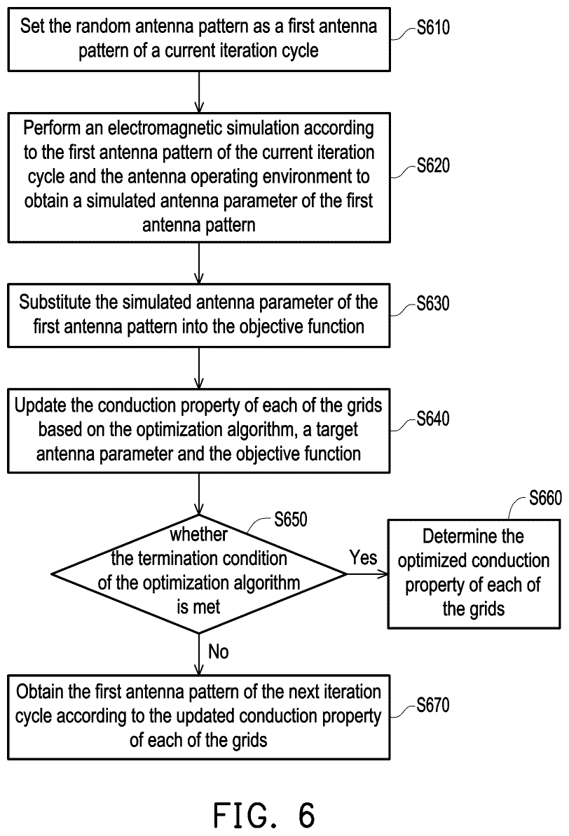

Referring to FIG. 6, in some embodiments, step S520 may be implemented as step S610 to step S670. First, in step S610, the processor 130 may set a random antenna pattern as a first antenna pattern of the current iteration cycle. Specifically, the processor 130 may use the random antenna pattern as the first antenna pattern of the first iteration cycle of the optimization algorithm. On the other hand, the processor 130 may obtain the first antenna pattern of the (i)-th iteration cycle (that is, the current iteration cycle) based on the conduction property of each grid determined by the (i−1)-th iteration cycle. Herein, ‘i’ is an integer greater than 1.

More specifically, in some embodiments, each grid in the antenna zone may correspond to a constant variable within a preset interval, and the optimization algorithm can automatically adjust the constant variables corresponding to these grids to achieve the optimization goal of the objective function. The processor 130 may set the initial value of the constant variable of each grid to the random constant corresponding to each grid, wherein the random constant corresponding to each grid is configured to determine the random antenna pattern. That is, the random constant corresponding to each grid generated in step S410 are the initial values of these constant variables in the optimization algorithm. In some embodiments, the optimization algorithm may automatically adjust the constant variables of these grids to optimize the S parameter.

In step S620, the processor 130 may perform an electromagnetic simulation according to the first antenna pattern of the current iteration cycle and the antenna operating environment to obtain the simulated antenna parameter of the first antenna pattern. Specifically, the electromagnetic simulation software may perform electromagnetic simulation based on the first antenna pattern and the antenna operating environment, and generate a simulated antenna parameter of the first antenna pattern. The simulated antenna parameter of the first antenna pattern includes the S parameter of the first antenna pattern.

In step S630, the processor 130 may substitute the simulated antenna parameter of the first antenna pattern into the objective function. In other words, in some embodiments, the processor 130 may set the simulated S parameter of the first antenna pattern of the current iteration cycle as the objective function.

In step S640, the processor 130 may update the conduction property of each of the grids based on the optimization algorithm, target antenna parameter and the objective function. In some embodiments, the processor 130 may execute an optimization algorithm based on the target antenna parameter to iteratively optimize the objective function to update the constant variable and corresponding conduction property of each grid. The constant variable of each grid may be configured to determine the conduction property of each grid. It should be noted that the correspondence between the constant variable of each grid and the conduction property is the same as the correspondence between the random constant and the conduction property of each grid in the aforementioned embodiments. For example, the processor 130 may also determine the conduction property of each grid by substituting the constant variable of each grid into formular (1).

In step S650, processor 130 may determine whether the termination condition of the optimization algorithm is met. In some embodiments, the termination condition of the optimization algorithm includes whether the number of iteration cycles reaches a preset number or whether the objective function converges.

If the determination in step S650 is yes, in step S660, the processor 130 may determine the optimized conduction property of each grid. When the number of iteration cycles of the optimization algorithm reaches a preset number or the objective function converges, the processor 130 may terminate execution of the optimization algorithm and obtain the optimal solution for the constant variables of these grids. In the disclosure of obtaining the optimal solution of the constant variables of these grids, the processor 130 may determine the optimized conduction property of each grid based on formular (1), for example. The optimal conductivity property of each grid may be a conductive metal material or a non-conductive material.

If the determination in step S650 is no, in step S670, the processor 130 may obtain the first antenna pattern of the next iteration cycle according to the updated conduction property of each grid. That is to say, when the number of iteration cycles of the optimization algorithm does not reach the preset number or the objective function does not converge, the processor 130 may determine another first antenna pattern for the next iteration cycle based on the updated conductive properties generated during the current iteration cycle. This allows for another optimization calculation to be performed for the next iteration cycle based on the newly determined first antenna pattern. Specifically, it means returning to step S620 after executing step S670.

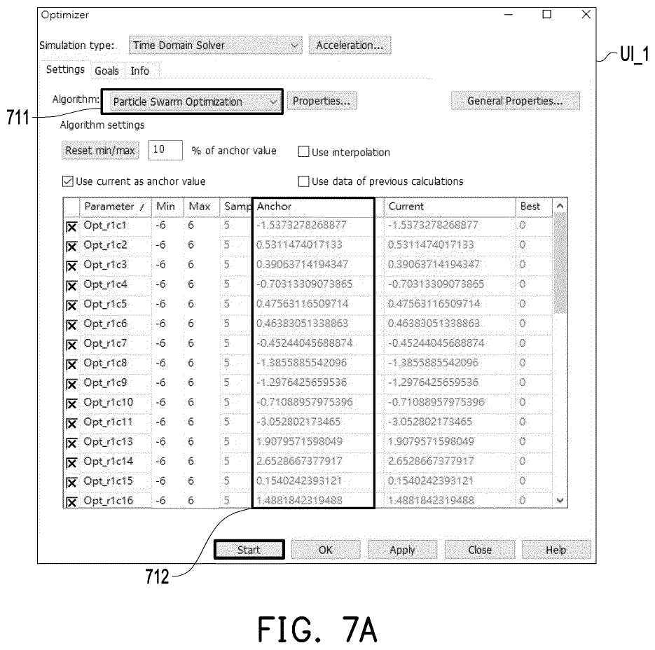

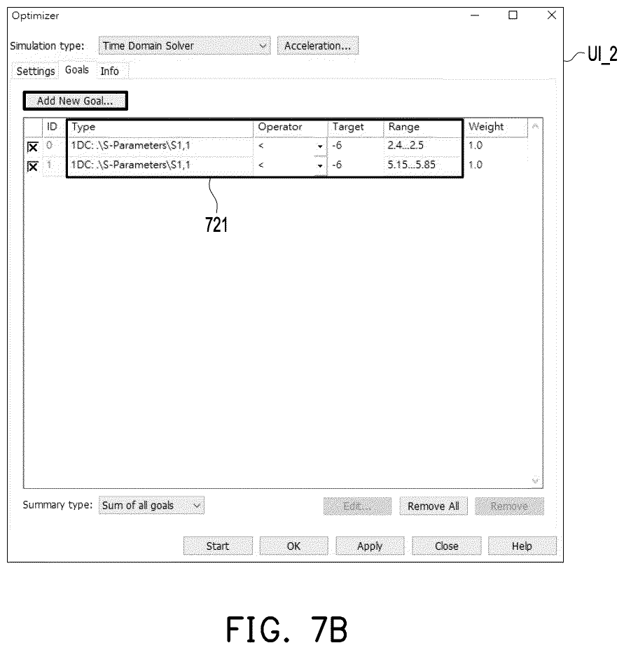

It should be noted that the operation shown in FIG. 6 may be realized by using the optimizer of electromagnetic simulation software, wherein the optimizer may find the optimized conduction property of each grid according to the selected optimization algorithm. For example, referring to FIG. 7A, the display 110 may display the operation interface UI_1 of the optimizer of the electromagnetic simulation software. The operation interface UI_1 includes a setting field 711 for setting the optimization algorithm of the optimizer. Field 712 in operation interface UI_1 includes random constant for each grid. For example, the random constant for grid Opt_rlc1 may be −1.5373278268877. In other words, the initial value of the constant variable of grid Opt_rlc1 may be −1.5373278268877.

Referring to FIG. 7B, the display 110 may display the operation interface UI_2 of the optimizer of the electromagnetic simulation software. Field 721 in operation interface UI_2 includes type of object function, a S parameter requirement, and a target operating frequency band. In this example, the type of object function may be S11 parameter. A S parameter requirement may include the operator “less than” and the target value of the S parameter “−6 db”. In addition, the target operating frequency band may include a first target operating frequency band corresponding to 2.4 GHZ and a second target operating frequency band corresponding to 5 GHZ. After completing the parameter setting of the optimizer as shown in FIG. 7A and FIG. 7B, the optimizer may determine the optimal constant variable and the corresponding optimized conduction property of each grid.

Afterwards, returning to FIG. 2, in step S250, the processor 130 may determine an antenna pattern designed to meet the antenna specification information based on the optimized conduction property of each of the grids. Specifically, the processor 130 may use a combination pattern of multiple grids whose optimized conduction properties are metal conductive materials as an antenna pattern. From another perspective, the processor 130 may determine that the pattern of the radiation patch is the antenna pattern.

In some embodiments, the processor 130 may perform an electromagnetic simulation according to the antenna pattern to obtain another simulated antenna parameter of the antenna pattern. Afterwards, the processor 130 may verify whether the antenna pattern is qualified according to another simulated antenna parameter. In some implementations, another simulated antenna parameter may include an antenna efficiency parameter. That is, the processor 130 may check whether the antenna efficiency parameter of antenna pattern meets the requirements (for example, is greater than the antenna efficiency threshold value).

In some embodiments, the processor 130 may utilize the display 110 to display the antenna pattern in a user interface. In addition, the processor 130 may use the display 110 to display the electromagnetic simulation result of the antenna pattern on a user interface. The electromagnetic simulation results of the antenna pattern may include simulated S parameter and antenna efficiency parameters, etc.

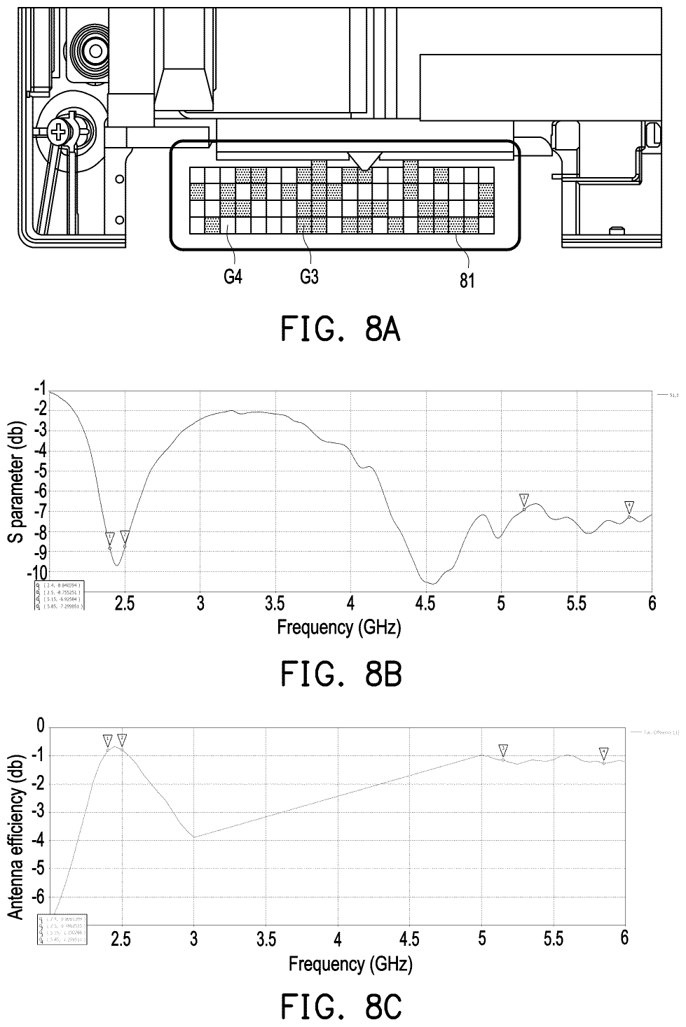

For example, referring to FIG. 8A, after executing an optimization algorithm for finding the optimized conduction property of each grid, the processor 130 may obtain antenna pattern 81. In the example of FIG. 8A, the optimized conduction property of a part of the grid filled with dots is a metal conductive material, and the optimized conduction property of another part of the grid without any filled pattern is a non-conductive material. For example, the optimized conduction property of grid G3 is a metal conductive material, while the optimized conduction property of grid G4 without any filled pattern is a non-conductive material. Referring to FIG. 8B, the processor 130 may perform electromagnetic simulation according to the antenna pattern 81 to obtain the S parameter of the antenna pattern 81. As shown in FIG. 8B, the simulated S parameter between 2.4 GHz and 2.5 GHz meet the S parameter requirement, and the simulated S parameter between 5.15 GHz and 5.85 GHz also meet the S parameter requirement. Referring to FIG. 8C, the processor 130 may perform electromagnetic simulation according to the antenna pattern 81 to obtain the antenna efficiency parameter of the antenna pattern 81. The processor 130 may check whether the antenna efficiency parameter of the antenna pattern 81 is greater than the antenna efficiency threshold to determine whether the antenna pattern 81 is qualified. If the antenna efficiency parameter of the antenna pattern 81 corresponding to the target operating frequency is greater than the antenna efficiency threshold, the processor 130 determines that the antenna pattern 81 is qualified.

In view of the foregoing, in the embodiments, the antenna zone may be divided into multiple grids. Afterwards, an optimization algorithm may be executed based on the target antenna parameter to determine the optimized conduction property of each grid in the antenna zone. Therefore, based on the optimized conduction property of each grid, the antenna pattern designed to meet the needs may be determined. In other words, by using an optimization algorithm to determine the optimized conduction property of each grid, an antenna pattern designed to meet the needs may be automatically determined. Based on this, it may not only greatly improve the efficiency of antenna design, but also be suitable for automatically designing antenna patterns that meet the needs of complex environments.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An antenna design method, comprising:
obtaining antenna specification information and antenna environment information, wherein the antenna specification information comprises a target antenna parameter and an antenna size;
dividing an antenna zone corresponding to the antenna size into a plurality of grids;
randomly assigning a conduction property of each of the grids to generate a random antenna pattern;
executing an optimization algorithm based on the target antenna parameter and the random antenna pattern to obtain an optimized conduction property of each of the grids; and
determining an antenna pattern designed to meet the antenna specification information based on the optimized conduction property of each of the grids.

2. The antenna design method according to claim 1, wherein the step of randomly assigning the conduction property of each of the grids to generate the random antenna pattern comprises:
generating a random constant within a preset interval for each of the grids;
mapping the random constant of each of the grids into a binary indication value, wherein the binary indication value corresponding to each of the grids is configured to indicate the conduction property of each of the grids; and
generating a random antenna pattern based on the binary indication value corresponding to each of the grids.

3. The antenna design method according to claim 2, wherein when the binary indication value of a first grid among the grids is a first value, the first grid is configured as a conductive metal material; when the binary indication value of the first grid among the grids is a second value, the first grid is configured as a non-conductive material.

4. The antenna design method according to claim 2, wherein the step of mapping the random constant of each of the grids to the binary indication value comprises:
mapping the random constant of the first grid to the first value when the random constant of the first grid among the grids is within the first value interval; and
mapping the random constant of the first grid to the second value when the random constant of the first grid among the grids is within the second value interval.

5. The antenna design method according to claim 1, wherein the target antenna parameter comprises a target operating frequency band and a S parameter requirement.

6. The antenna design method according to claim 1, wherein the step of executing the optimization algorithm based on the target antenna parameter and the random antenna pattern to obtain the optimized conduction property of each of the grids comprises:
determining an objective function of the optimization algorithm; and
executing the optimization algorithm by setting the random antenna pattern as an initial state to obtain the optimized conduction properties of the grids for optimizing the objective function.

7. The antenna design method according to claim 6, wherein the step of executing the optimization algorithm by setting the random antenna pattern as the initial state to obtain the optimized conduction properties of the grids for optimizing the objective function comprises:
performing an electromagnetic simulation according to a first antenna pattern of a current iteration cycle and the antenna environment information to obtain a simulated antenna parameter of the first antenna pattern;
substituting the simulated antenna parameter of the first antenna pattern into the objective function; and
updating the conduction property of each of the grids based on the optimization algorithm, the target antenna parameter and the objective function.

8. The antenna design method according to claim 1, further comprising:
displaying the antenna pattern in a user interface.

9. The antenna design method according to claim 1, wherein the step of determining the antenna pattern designed to meet the antenna specification information based on the optimized conduction property of each of the grids comprises:
performing an electromagnetic simulation according to the antenna pattern to obtain another simulated antenna parameter of the antenna pattern; and
verifying whether the antenna pattern is qualified according to the another simulated antenna parameter.

10. An electronic device, comprising:
a storage device, records multiple instructions;
a processor, coupled to the storage device, accesses the instructions and configured to:
obtain antenna specification information and antenna environment information, wherein the antenna specification information comprises a target antenna parameter and an antenna size;
divide an antenna zone corresponding to the antenna size into a plurality of grids;
randomly assign a conduction property of each of the grids to generate a random antenna pattern;
execute an optimization algorithm based on the target antenna parameter and the random antenna pattern to obtain an optimized conduction property of each of the grids; and
determine an antenna pattern designed to meet the antenna specification information based on the optimized conduction property of each of the grids.
